(19) United States
(12) Patent Application Publication
(10) Pub. No.: US 2025/0317362 A1
(43) Pub. Date: Oct. 9, 2025

(54) METHODS, APPARATUS AND COMPUTER-READABLE MEDIA FOR MANAGING A SYSTEM OPERATIVE IN A TELECOMMUNICATION ENVIRONMENT

(71) Applicant: Telefonaktiebolaget LM Ericsson (PUBL), Stockholm (SE)

(72) Inventors: Dan Wang, Saint-Laurent (CA); Maxime Bouton, Stockholm (SE); Jaeseong JEONG, SOLNA (SE); Paul Smith, Roscommon (IE)

(21) Appl. No.: 18/866,202

(22) PCT Filed: May 16, 2022
(86) PCT No.: PCT/EP2022/063217

§ 371 Date: Nov. 15, 2024

(51) Int. Cl. H04L 41/14; H04L 41/16

(52) U.S. Cl. CPC H04L 41/145; H04L 41/16

(57) ABSTRACT

A computer implemented method is provided for managing a system operative in a telecommunication environment. Managing the system comprises causing the system to implement an action, the action being one of a set of available actions. The method comprises: analysing data relating to a state of the telecommunication environment, using a rule-based algorithm, to determine a recommended first action from the set of available actions; and removing, from the set of available actions, a second action which opposes the recommended first action, to generate a reduced set of available actions. The method further comprises: analysing data relating to a state of the telecommunication environment, using a reinforcement learning algorithm, to select a third action from the reduced set of available actions; and causing the system to implement the third action.

### TECHNICAL FIELD

Embodiments of the present disclosure relate to methods, apparatus and computer-readable media for managing a system operative in a telecommunications environment, and particularly to methods for causing the system to implement an action from a set of available actions.

### BACKGROUND

A Radio Access Network (RAN) may comprise hundreds of thousands of cells. Each cell has a number of parameters which can be tuned to optimise network performance (e.g., cell coverage, cell capacity, etc) within the cell. A cell can monitor its network performance via key performance indicators (KPIs) observed within the cell (e.g., cell throughput, edge cell signal strength, etc). However, network operators are usually interested in global KPIs (e.g., throughput averaged over multiple or all cells of a network, etc), such that they can ensure an adequate network performance is experienced by a large proportion of network users. Thus, network configuration often aims at optimising global KPIs rather than KPIs of individual cells. This may be achieved through having a RAN act as a self-organising network (SON).

The performance of a cell (and thus its KPIs) can be improved through adjusting cell parameters. One method of adjusting cell parameters involves cell shaping. Cell shaping uses beamforming techniques to shape an overall coverage area of a cell. For example, remote electrical tilt (RET) and/or digital tilt can define the tilt of an antenna of a base station serving a cell. Changes to antenna tilt can be performed remotely. By modifying the antenna tilt of a base station serving a particular cell, the downlink (DL) signal to interference plus noise ratio (SINR) for that cell can be changed. However, the SINR of surrounding cells may also be affected as a result.

FIG. 1 illustrates how neighbouring first and second cells 106a, 106b (served by RAN nodes 102a, 102b) may affect one another due to their overlapping coverage areas. The resulting signal interference may impact the network performance experienced by first and second user equipments (UEs) 104a, 104b served by each cell. Through adjusting a downtilt angle, θ, of the antenna(s) of each RAN node 102a, 102b, the shape of each cell 106a, 106b may be tuned such that the combined network performance of both cells is optimised. This may involve the network performance being improved for the first UE 104a within the first cell 106a, but degraded for the second UE 104b in the second cell 106b.

Another method of adjusting cell parameters involves adjusting the power of signals transmitted within the cell. For example, P0 Nominal Physical Uplink Shared Channel (PUSCH) defines the target power per resource block (RB) which the cell expects in uplink (UL) communication from a UE to a base station. By increasing this target power in a particular cell, the UL SINR in the cell may increase (due to an increase in signal strength). However, as a result, the UL SINR in surrounding cells may decrease (due to an increase in signal interference).

Both of the above parameter adjustments may be implemented in various ways. One implementation method uses a rule-based algorithm, which is pre-configured with logic and/or function(s). A current state of a cell, which may determine one or more KPIs of the cell, can be input into the algorithm. A recommended action to be implemented by the base station serving the cell is output from the algorithm. The rule-based algorithm may be pre-configured such that the recommended action at least maintains (but ideally improves) the state of the cell.

Machine-learning techniques such as reinforcement learning (RL) are increasingly being used to replace rule-based algorithms.

In more detail, RL is a decision-making framework in which an agent interacts with an environment by exploring its states and selecting actions to be executed on the environment. Actions are selected with the aim of maximising the long-term return of the actions according to a reward signal. More formally, an RL problem is defined by:
The state space s: which is the set of all possible states in which the environment may exist.
The action space A: which is the set of all possible actions which may be executed on the environment,
The transition probability distribution P: which is the probability of transitioning from one state to another based on an action selected by the agent,
The reward distribution R: which incentivises or penalises specific state-action pairs.

The agent's policy π, defines the control strategy implemented by the agent, and is a mapping from states to a policy distribution over possible actions, the distribution indicating the probability that each possible action is the most favourable given the current state. An RL interaction proceeds as follows: at each time instant t, the agent finds the environment in a state sₜϵS. The agent selects an action at aₜ˜π(·|sₜ)ϵA, receives a stochastic reward rₜ˜R(·|sₜ, aₜ), and the environment transitions to a new state sₜ₊₁˜P(·|sₜ, aₜ). The agent's goal is to find the optimal policy, i.e. a policy that maximizes the expected cumulative reward over a predefined period of time, also known as the policy value function

$${V}^{π} ( s ) = {π}_{} [ {\sum }_{i = 0}^{∞} {γ}^{i} {r}_{t + i} \vert {s}_{t} = s ] .$$

While executing the above discussed dynamic optimisation process in an unknown environment (with respect to transition and reward probabilities), the RL agent needs to try out, or explore, different state-action combinations with sufficient frequency to be able to make accurate predictions about the rewards and the transition probabilities of each state-action pair. It is therefore necessary for the agent to repeatedly choose suboptimal actions, which conflict with its goal of maximizing the accumulated reward, in order to sufficiently explore the state-action space. At each time step, the agent must decide whether to prioritize further gathering of information (exploration) or to make the best move given current knowledge (exploitation). Exploration may create opportunities by discovering higher rewards on the basis of previously untried actions. However, exploration also carries the risk that previously unexplored decisions will not provide increased reward and may instead have a negative impact on the environment. This negative impact may only be short term or may persist, for example if the explored actions place the environment in an undesirable state from which it does not recover.

RL solutions have been shown to result in reasonable performance gains in real-world deployment (e.g., Al: enhancing customer experience in a complex 5G world, Ericsson Mobility Report 2021).

### SUMMARY

There currently exist certain challenges. Performance improvements achieved using the rule-based algorithm are limited; the logic and/or function(s) employed by the rule-based algorithm are not iteratively trained or optimised, and so the performance of the rule-based algorithm is not expected to improve over time. The rule-based algorithm will simply output an action according to its preconfigured set of rules for a given state of a cell.

Reinforcement learning may be applied to the problem of optimizing cell parameters. However, whilst an RL agent can be continually trained to recommend an optimal action, the RL agent can be considered a black box model in the sense that there is no discernible reason as to why the RL agent will output an estimated cumulative future reward for a certain action. Moreover, exploration of suboptimal regimes may result in unacceptable performance degradation, risk taking, or breaching of safety regulations for the cellular network. This means that the reliability and safety of the action recommended by the RL agent cannot be guaranteed. RL agents can therefore be risky to implement in telecommunication networks, as any action which negatively impacts network performance could cause wide-spread performance issues for many users. In order to utilise RL agents, the associated risk of harmful actions being implemented should be reduced and/or minimised.

Through combining rule-based algorithms and RL algorithms, existing domain knowledge can be used to prevent potentially harmful actions (recommended by the RL algorithm) from being implemented. As such, RL agents can be employed in real network environments whilst simultaneously helping to ensure a high level of safety for the environment.

In one aspect, there is provided a computer implemented method for managing a system operative in a telecommunication environment. Managing the system comprises causing the system to implement an action, the action being one of a set of available actions. The method comprises: analysing data relating to a state of the telecommunication environment, using a rule-based algorithm, to determine a recommended first action from the set of available actions; and removing, from the set of available actions, a second action which opposes the recommended first action, to generate a reduced set of available actions. The method further comprises: analysing data relating to a state of the telecommunication environment, using a reinforcement learning algorithm, to select a third action from the reduced set of available actions; and causing the system to implement the third action.

Apparatus and a computer-readable medium for performing the method set out above are also provided. For example, there is provided a management node for managing a system operative in a telecommunication environment. Managing the system comprises causing the system to implement an action, the action being one of a set of available actions. The management node comprises processing circuitry configured to: analyse data relating to a state of the telecommunication environment, using a rule-based algorithm, to determine a recommended first action from the set of available actions; and remove, from the set of available actions, a second action which opposes the recommended first action, to generate a reduced set of available actions. The processing circuitry is further configured to: analyse data relating to a state of the telecommunication environment, using a reinforcement learning algorithm, to select a third action from the reduced set of available actions; and cause the system to implement the third action.

Examples of the present disclosure provide a method that facilitates the use of RL agents for controlling a telecommunication environment without risking network performance. Thus, network performance can be optimised whilst ensuring a level of safety for the network.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic diagram illustrating two neighbouring network cells;

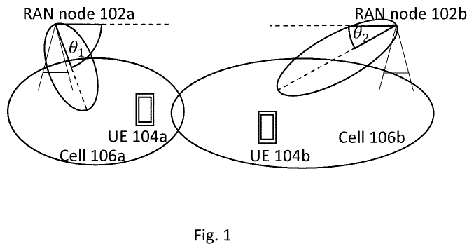

FIG. 2 is a schematic diagram illustrating a communication network according to embodiments of the disclosure;

FIG. 3 is a schematic diagram showing a management architecture and an environment according to embodiments of the disclosure;

FIG. 4 is a signalling diagram illustrating signalling between a SON agent, a DQN agent, and a management node according to embodiments of the disclosure;

FIG. 5 is a flowchart of a method performed by a management node according to embodiments of the disclosure; and

FIG. 6 is a schematic diagram of a management node according to embodiments of the disclosure.

### DETAILED DESCRIPTION

Some of the embodiments contemplated herein will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Examples of the present disclosure propose a method for Safe Reinforcement Learning (SRL), and an architecture on which it may be implemented, that change the standard RL interaction cycle so as to improve the safety of an environment in which RL techniques are being employed. Conceptually, the method may be envisaged as masking a set of actions from which an RL agent can select an action to be implemented by a system operating in the environment. Masking the set of available actions involves removing any action from the set of actions which directly oppose a “safe” action. An action may be considered “safe” in the sense that it can be known, with some degree of certainty, to improve or cause no change to the state of the environment. Such safe actions may be reliably determined using a rule-based algorithm preconfigured with existing domain knowledge.

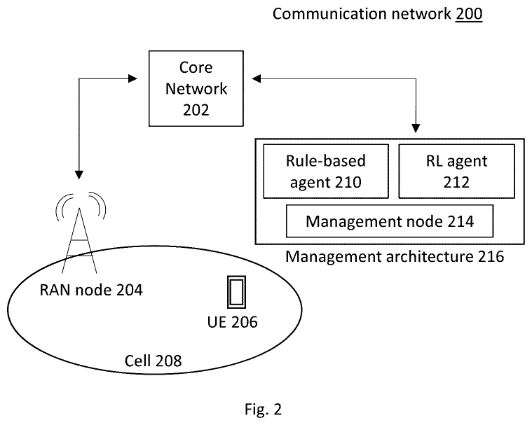

FIG. 2 is a schematic diagram illustrating a communication network 200 according to embodiments of the disclosure. The communication network 200 may be a self-organizing network (SON) in some embodiments, where one or more parameters associated with the network 200 are determined by entities of the network 200 autonomously.

In the illustrated embodiment, the communication network 200 comprises a radio-access network (RAN), which includes one or more RAN nodes 204, and a core network 202, which includes one or more core network nodes. The RAN comprises a RAN node 204. As used herein, the term “RAN node” refers to equipment capable, configured, arranged and/or operable to communicate directly or indirectly with a wireless device or user equipment (UE) and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and New Radio NodeBs (gNBs)). The RAN node serves one or more UEs 206 in a serving cell 208. The RAN node 204 facilitates direct or indirect connection of UEs in its serving cell 208, such as by connecting the UE 206 to the core network 202 over one or more wireless connections.

The core network 202 includes one more core network nodes that are structured with hardware and software components. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

According to embodiments of the disclosure, the core network 202 comprises a management architecture 216 that enables the safe usage of reinforcement learning (RL) to adapt, control and/or manage one or more aspects of the network 200. For example, in one embodiment, the management architecture 216 is configured to determine an action to be implemented by the RAN node 204 (e.g., a change to a downtilt of an antenna of the RAN node 204, or a change in the P0 nominal PUSCH), such that the shape or parameters of the serving cell 208 may be adjusted. This in turn allows for the performance of the network 200 to be optimised.

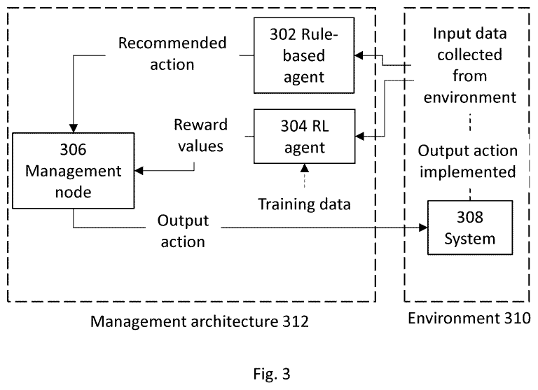

The management architecture 216 may be implemented using any one or more of the core network nodes discussed above, or alternatively in one or more servers attached to the core network 202. In a further alternative embodiment, the management architecture 216 may be implemented in the RAN, e.g., in the RAN node 204 itself, or another RAN node. For example, the management architecture 216 may be implemented using a Service Management and Orchestration (SMO) system or a non-Real Time Radio Intelligent Controller (non-RT-RIC). In the illustrated embodiment, the management architecture 216 comprises a rule-based agent 210, an RL agent 212, and a management node 214. These aspects are discussed in more detail with respect to FIG. 3.

FIG. 3 is a schematic diagram illustrating a management architecture 312 and an environment 310 according to embodiments of the disclosure. The management architecture 312 may correspond to the management architecture 216 described above with respect to FIG. 2, for example. The management architecture 312 comprises a rule-based agent 302, an RL agent 304, and a management node 306 (e.g., corresponding to the rule-based agent 210, the RL agent 212, and the management node 214 respectively).

According to embodiments of the disclosure, the environment 310 may comprise a telecommunication network or part of a telecommunication network. For example, the environment may comprise or correspond to a radio access network (RAN), one or more RAN nodes (such as the RAN described above with respect to FIG. 2, for example) or one or more cells served by those RAN nodes. In a further example, the environment may additionally or alternatively comprise or correspond to one or more wireless devices or user equipments (UEs). In another example, the environment 310 may additionally or alternatively comprise a core network (such as the core network 202 described above), or one or more core network nodes. A system 308 is operative in the environment 310 and executes actions in the environment 310 under control of the management architecture 312. For example, the system 308 may correspond to a communication node or device within the telecommunication network, such as a RAN node, a core network node or a UE. Alternatively, the system 308 may correspond to a relevant part of a communication node or device within the telecommunication network, such as processing circuitry thereof.

The management node 306 is configured with a set of available actions that may be performed by the system 308 for a particular task. For example, where the system 308 corresponds to a RAN node, one task may correspond to setting the tilt of an antenna. In this case, the set of available actions may correspond to a set of relative adjustments to the antenna tilt, such as “tilt antenna up by X degrees”, “tilt antenna down by X degrees” and “no change” (where X is a number). The management node 306 selects an action from the set of available actions, and outputs the action to the system 308 to be implemented.

According to embodiments of the disclosure, the management architecture 312 comprises at least two different mechanisms by which the management node 306 selects the action to be output to the system 308: a rule-based mechanism, implemented by the rule-based agent 302; and a RL mechanism, implemented by the RL agent 304.

The rule-based agent 302 is configured to recommend an action (from the set of available actions configured in the management node 306) for the system 308 to implement. The action is recommended by the rule-based agent 302 based on the state of the environment 310, and using one or more preconfigured rules.

Thus data is collected from the environment 310 and provided to the rule-based agent 302. In some embodiments, the data may comprise information relating to the state of the environment 310.

The state of the environment 310 comprises values for one or more performance parameters measuring the performance of the environment or a part of the environment. The one or more performance parameters may thus measure the performance of a single part of the environment, or the performance of the environment as a whole.

As noted above, the environment is a telecommunication environment and may comprise a telecommunication network or part of a telecommunication network. The state of the environment in such embodiments may thus relate to the performance of the entire telecommunication network or the performance of the part of the telecommunication network. The telecommunication network may comprise one or more physical nodes or entities (e.g., base stations, UEs, core network nodes, etc), one or more virtual nodes or entities (e.g., a network node or entity defined in software), and/or one or more logical entities (e.g., cells, tracking areas, public land mobile networks (PLMNs), etc). The part of the telecommunication network may comprise any one or more of these nodes or entities.

For example, the state of the environment may comprise one or more performance parameters measuring the performance of one or more physical or virtual nodes such as RAN nodes. In such a case, the one or more performance parameters may comprise one or more of: a quality of experience (QoE) associated with services provided by the RAN node; a quality of service (QOS) associated with services provided by the RAN node; statistics relating to handover between RAN nodes (e.g., number of handover attempts, handover success ratio, etc); a number of radio measurement reports received by the RAN node from served UEs; radio measurements (e.g., RSRP, RSRQ, SINR, etc) reported to the RAN node; and a number or proportion of error reports (e.g., negative acknowledgements) received by the RAN node.

Additionally or alternatively, the state of the environment may comprise one or more performance parameters measuring the performance of one or more physical or virtual nodes such as wireless devices or UEs. In such a case, the one or more performance parameters may comprise one or more of: a power usage of the one or more UEs; radio measurements (e.g., RSRP, RSRQ, SINR, etc) taken by the one or more UEs; a number of error reports (e.g., negative acknowledgements) transmitted by the one or more UEs and/or received by the UEs; and a number or proportion of radio link failures or handover failures experienced by the one or more UEs.

Additionally or alternatively, the state of the environment may comprise one or more performance parameters measuring the performance of one or more logical entities (e.g., cells, tracking areas, PLMNs, etc) of the telecommunication environment. In such a case, the performance parameters may comprise any one or more of: a capacity of the one or more logical entities; a throughput of the one or more logical entities; statistics relating to handover between cells (e.g., number of handover attempts, handover success ratio, etc); total number of users camped on the logical entity; a coverage of the one or more logical entities; and a signal strength at an edge of the one or more cells.

Any of these one or more performance parameters may be measured instantaneously or over a period of time. In the latter case, the values for the performance parameters may be averaged over the period of time. Further, multiple sets of data (e.g., collected during different time periods) may be averaged to determine one or more time-averaged performance parameters for the environment.

The rules implemented by the rule-based agent 302 may be preconfigured using existing domain knowledge relating to the environment 310, such that the rule-based agent 302 recommends an action which is known or expected (to a high degree of certainty) to improve or at least maintain the state of the environment 310. For example, the action recommended by the rule-based agent 302 may maintain or improve one or more performance parameters of the state of the environment.

In this context, “improving” the state of the environment may comprise improving one or more performance parameters representing the state of the environment. Note that, depending on the definition of the performance parameter, improving the parameter may comprise increasing or decreasing the value of that parameter. For example, performance parameters such as SINR, RSRP, handover success ratio, etc are improved by increasing the values of those parameters. Conversely, performance parameters such as number of radio link failures or handover failures, number of received error reports, etc are improved by decreasing the values of those parameters.

One or more performance parameters representing the state of the environment may carry greater weight than other performance parameters, when determining whether the state of the environment is improved in an overall sense. For example, it may be considered more important to achieve improvement in one or more performance parameters representing the environment as a whole (e.g., overall throughput of the network, etc) rather than improvement in one or more performance parameters representing specific parts of the environment (e.g., throughput of any one particular network node). In one embodiment, improvement of the environment may be determined based on the values for one or more performance parameters, and ignoring the values of other performance parameters.

The preconfigured rules implemented by the rule-based agent 302 may operate in a logical or deterministic manner such that, given the same input data, the same action is recommended by the rule-based agent. For example, the preconfigured rules may comprise one or more functions to be applied to the performance parameters, where the outputs of the functions are used to determine the recommended action (e.g., by comparison of those outputs to one or more thresholds). The functions and/or thresholds may be determined on the basis of domain knowledge of the environment 310, as set out above.

Thus the rule-based agent 302 determines a recommended action for the system 308, based on the state of the environment 310 indicated by the input data, and outputs this recommended action to the management node 306. It can be assumed (with a high degree of certainty) that the action recommended by the rule-based agent 302 will not negatively impact the state of the environment 310 once implemented by the system 308.

As noted above, conventional RL agents interact with an environment by exploring its states and selecting actions to be executed on the environment. Actions are selected with the aim of maximising the long-term return of the actions according to a reward signal. In the context of embodiments of the disclosure, the RL agent 304 is configured to interact with the environment 310 by exploring its states and outputting reward values associated with each action to the management node 306. It is the management node 306 which selects the action to be implemented by the system 308.

The RL agent 304 may therefore comprise an RL model configured to estimate, based on the state of the environment 310, a reward value as a result of the system 308 implementing a given output action. The reward value may be based on an estimated improvement to the state of the environment 310 as a result of implementation of the action. The reward may be an estimate of at least one of: an immediate reward for implementing the action and a cumulative future reward for implementing the action.

In particular embodiments of the disclosure, the RL agent 304 calculates a plurality of reward values using the RL model and the state of the environment 310 as input. Each reward value may correspond to an estimated reward for implementing a respective action of the set of available actions. The RL model may be a Deep Q network (DQN) model and the reward values may be Q-values. The plurality of reward values is sent to the management node 306.

The management node 306 thus receives the recommended action and the plurality of reward values from the rule-based agent 302 and RL agent 304, respectively. According to embodiments of the disclosure, where an action from the set of available actions opposes the recommended action, this opposing action is removed or masked from the set of available actions. Note that, if there is no action which opposes the recommended action, no action may be removed from the set of available actions.

In the context of the present disclosure, a first action opposes a second action where the first action indicates in a change to a configuration of the system 308, or a parameter of the system 308, and the second action indicates in a change to the configuration of the system 308 or the parameter of the system 308 which has an opposite effect on the configuration or parameter. For example, where the first action indicates a positive change to a parameter, a second action indicating a negative change to the parameter opposes the first action (and vice versa). Thus, in some embodiments, two actions oppose each other where they indicate opposite-signed changes to a parameter. In further embodiments, the magnitude of the change may also be relevant to determining whether an action opposes another action. In such a case, a second action may oppose a first, recommended action where the second action indicates an opposite-signed change to a parameter, and the absolute magnitude of the change indicated by the second action is the same as or greater than the absolute magnitude of the first action. Consider the example where the task performed by the system is to control antenna tilt, and the set of available actions includes the following: −10 degree tilt; −5 degree tilt; −1 degree tilt; no change; +1 degree tilt; +5 degree tilt; and +10 degree tilt. If the rule-based agent recommends a +5 degree tilt, opposing actions may be considered to include-10 degree and −5 degree tilts.

The management node 306 then selects, from this reduced set of actions (i.e., the set of available actions with any ‘opposing’ action removed) and based on the output of the RL agent 304, an action to be implemented by the system 308. For example, particularly where the management node 306 implements an exploitation phase, the management node 306 may select the objectively best action from the reduced set of actions, e.g., the action associated with the highest or greatest reward value. In many cases, this action will correspond to the action recommended by the rule-based agent 302. That is, both the rule-based agent 302 and the RL agent 304 will recommend the same action. Where the management node 306 implements an exploration phase, the management node 306 may select an action that is not associated with the highest or greatest reward value, but may instead select a different action with the objective of exploring the available state space. In either case, the action opposing the action recommended by the rules-based agent 302 is not selectable, and thus the management node 306 is prevented from selecting an action that may result in an undesirable outcome. The management node 306 outputs the selected action to the system 308 for implementation.

This process may be performed repeatedly (e.g. periodically). With each repetition, the RL agent 304 may be trained using training data (e.g., performance data collected from the environment 310) collected during and/or after implementation of an action, such that the RL model is trained to output reliable reward values. In this way, the management node 306 is enabled to select actions which maximise the reward returned for their implementation.

According to embodiments of the disclosure, the system 308 is therefore prevented from implementing an action which is known to counter (or be contrary to) an action which does not negatively impact the state of the environment 310. As previously discussed, when the environment 310 is a telecommunication environment, small changes to the state of the telecommunication environment can have wide-ranging effects on network performance. As such, actions which have the potential to impact the state of the telecommunication environment negatively should be avoided.

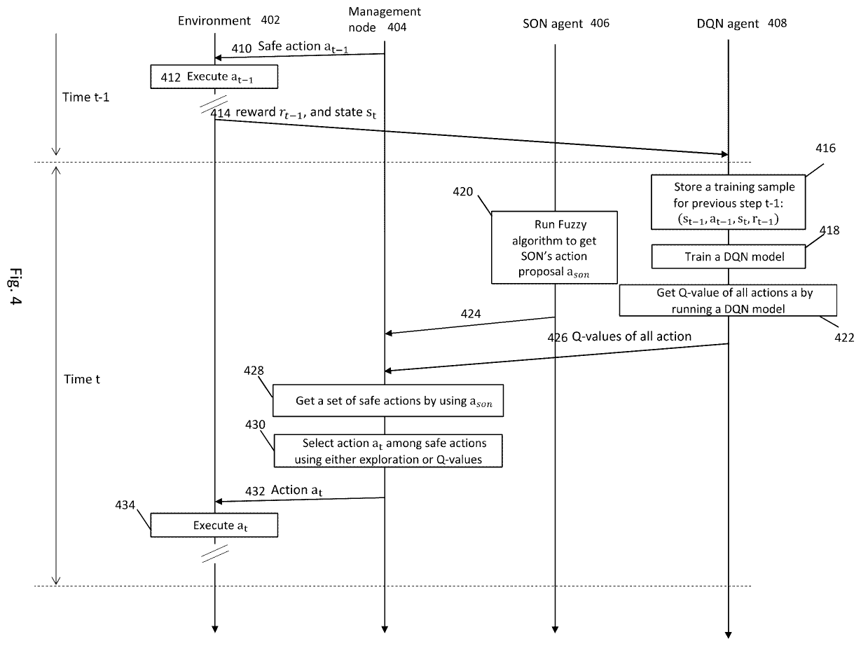

FIG. 4 is a signalling diagram illustrating signalling between a SON agent 406, a DQN agent 408, and a management node 404 according to embodiments of the disclosure. The signalling diagram illustrates two time steps, t−1 and t, of an iterative process through which an action, a, may be determined by the management node 404 to be executed in an environment 402 at the end of a given time step. The SON agent 406 may correspond to the rule-based agent 210, 302 described above; the DQN agent 408 may correspond to the RL agent 212, 304; the management node 404 may correspond to the management node 214, 306; and the environment may correspond to the environment 310 described above.

The signalling begins in a first time step, t−1. In step 410, the management node 404 forwards an action, aₜ₋₁, to be executed in the environment 402. At step 412, the action is executed in the environment 402 (e.g., by a system in the environment 402). At step 414, the DQN agent obtains: a reward value, rₜ₋₁, returned for executing the action; and a state of the environment, sₜ, after the execution of the action (i.e., at the end of the first time step).

In a second time step, t, at step 416, the DQN agent stores training data comprising information relating to the previous iteration of the method in the first time step. For example, the DQN agent may store one or more of: the executed action (aₜ₋₁); the state of the environment before the execution of the action (i.e., at the beginning of the first time step), sₜ₋₁; the state of the environment after the execution of the action (i.e., at the end of the first time step), sₜ; and the reward resulting from the execution of action, rₜ₋₁. At step 418, the DQN agent 408 trains a DQN model using the stored training data.

At step 420, the SON agent 406 uses a rule-based algorithm to propose an action, aₛₒₙ.

This action is one of a set of available actions which may be proposed by the SON agent 406. As previously discussed in relation to FIG. 3, the rule-based algorithm may propose an action which is known, to a high degree of certainty, to either maintain or improve a state of the environment 402 when implemented. In the illustrated embodiment, the output of the SON agent 406 is termed a “safe” action, in that the action is known not to reduce the performance of the environment 402. In step 424, the proposed action is forwarded to the management node 404.

At step 422, the DQN agent 408 calculates a reward value for each action of the set of available actions. In some embodiments, the reward values are Q-values which estimate a cumulative future reward for implementing a respective action of the set of available actions. In step 426, the reward values are sent to the management node 404.

At step 428, the management node 404 determines whether any action of the set of available actions opposes the SON proposed action. If such an opposing action exists, the management node 404 generates a reduced set of available actions by removing the opposing action from the set of available actions.

At step 430, the management node selects an action from the reduced set of available actions. For example, if the management node 404 determined at step 428 that no action opposed the action recommended by the SON agent, the management node 404 determines an action, at, to be executed in the environment 402 from the set of available actions. On the other hand, if the management node 404 at step 428 removes an action from the set of available actions, the management node 404 determines an action, at, to be executed in the environment 402 from the reduced set of available actions. In either scenario, the action (aₜ) may be determined from the respective set of actions using a policy of the RL agent. For example, the determined action may have the highest associated reward value. Alternatively, an exploration algorithm may be used to select a different action and so explore the state space of the environment 402. Epsilon-Greedy, Softmax or Upper Confidence Bound algorithms may be used for this purpose.

At step 432, the action (aₜ) is output from the management node 404 to be executed by a system operating in the environment 402 and, at step 434, the action is executed in the environment 402.

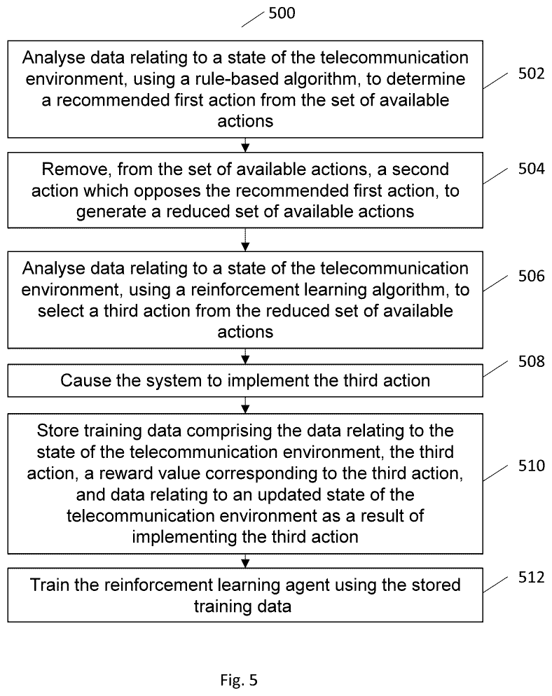

FIG. 5 is a flow chart illustrating process steps in a computer implemented method 500 for managing a system operative in a telecommunication environment. The method may be implemented using the management architecture described above with respect to FIGS. 2 and 3. The method may correspond to the signalling and actions set out with respect to the management node 404, the SON agent 406 and the DQN agent 408 with respect to FIG. 4. In some embodiments, the telecommunication environment may comprise at least one of a RAN and a SON. In some embodiments, the system may be a network node, such as a base station. The base station may comprise one or more radio antennas. Managing the system comprises causing the system to implement an action, the action being one of a set of available actions.

The method begins in step 502, in which data relating to a state of the telecommunication environment is analysed, using a rule-based algorithm, to determine a recommended first action from the set of available actions. In some embodiments, the data relating to the state of the telecommunication environment comprises one or more parameters relating to a performance characteristic of the telecommunications environment. The performance characteristic may be a KPI.

The recommended first action may be determined by the rule-based algorithm to either improve or cause no change to the state of the telecommunication environment. For example, the action may improve, or cause no change to, one or more performance characteristics of the telecommunication environment. Examples of (use-case specific) rule-based algorithms are discussed further below.

Referring still to FIG. 5, the method further comprises, in step 504, removing, from the set of available actions, a second action which opposes the recommended first action, to generate a reduced set of available actions. The two actions may oppose (i.e. counter) one another in the sense that they are the inverse of one another. Examples of such opposing actions are opposite changes to a parameter, such as: increasing or decreasing a vertical tilt of an antenna, increasing or decreasing a target power per resource block received by an antenna, and increasing or decreasing a horizontal width of a cell sector.

The method further comprises, in step 506, analysing data relating to a state of the telecommunication environment, using a reinforcement learning algorithm, to select a third action from the reduced set of available actions. This data may be the same data analysed by the rule-based algorithm. The RL algorithm may be a separate algorithm to the rule-based algorithm. In some embodiments, the data relating to the state of the telecommunication environment comprises one or more parameters relating to a performance characteristic of the telecommunications environment. The performance characteristic may be a KPI. The recommended first action and the third action may correspond to the same action of the set of available actions.

In some embodiments, analysing the data using the reinforcement learning algorithm may comprise obtaining, from a reinforcement learning agent, a plurality of reward values. Each reward value may relate to an estimated reward for implementing a respective action of the set of available actions (e.g., an immediate reward and/or a cumulative future reward). The estimated reward may be based on a calculated impact of the respective action on the state of the telecommunication environment. The third action may be selected based on the plurality of reward values. For example, the action having a highest reward value of the plurality of reward values may be selected as the third action, or the third action may be selected based on a reinforcement learning exploration strategy and the plurality of reward values.

In step 508, the system is caused to implement the third action.

In some embodiments, the method further comprises, in response to causing the system to implement the third action, storing 510 training data comprising the data relating to the state of the telecommunication environment, the third action, a reward value corresponding to the third action, and data relating to an updated state of the telecommunication environment as a result of implementing the third action. The method may further comprise training 512 the reinforcement learning agent using the stored training data.

In some embodiments, the reinforcement learning agent is a DQN agent and the reward values are Q-values.

In some embodiments, the method further comprises refraining from removing any action from the set of available actions responsive to a determination that there is no second action opposing the recommended first action. The method may further comprise analysing data relating to a state of the telecommunication environment, using the reinforcement learning algorithm, to determine a third action from the set of available actions. Again, in some embodiments, the recommended first action and the third action may correspond to the same action of the set of available actions.

In some embodiments, the one or more parameters comprise indications of any one or more of: a coverage of at least one network cell in the telecommunications environment; a capacity of at least one network cell in the telecommunications environment; a quality of experience (QoE) associated with services provided by a RAN of the telecommunications environment; a quality of service (QOS) associated with services provided by a RAN of the telecommunications environment; a signal strength at an edge of at least one network cell in the telecommunications environment; an average throughput of a plurality of network cells in the telecommunications environment; and an average coverage of the plurality of network cells.

In some embodiments, using the rule-based algorithm comprises applying a function to the data relating to the state of the telecommunication environment. The method may further comprise: comparing an output of the function to a threshold; and determining the recommended first action based on the comparison. This threshold may be adjusted in order to tune the frequency at which the rule-based algorithm determines the recommended first action to be an action having an opposing action. That is, if the recommended first action has no opposing action, then no second action is removed from the set of available actions (i.e., no generation of a reduced set of available actions). By adjusting the threshold so that the rule-based algorithm has a greater likelihood of recommending an action that results in no change, the RL algorithm is given more freedom in selecting the third action amongst the full set of available actions, allowing for increased exploration of the search space.

In some embodiments, the system comprises at least one antenna, and the set of available actions is for controlling a tilt of the at least one antenna. For example, the set of available actions may comprise: an uptilt of the at least one antenna; a down tilt of the at least one antenna; and no change to the tilt of the at least one antenna.

In some embodiments, the system comprises at least one antenna, and the set of available actions is for controlling a target power per resource block received by the at least one antenna (e.g., P0 Nominal PUSCH). For example, the set of available actions may comprise: an increase in the target power per resource block received by the at least one antenna; a decrease in the target power per resource block received by the at least one antenna; no change to the target power per resource block received by the at least one antenna.

There now follows a detailed discussion of two example use cases, illustrating how the methods of the present disclosure may be implemented to address example technical scenarios.

### Use Case 1: Remote Electronic Tilt

Modern cellular networks increasingly face the need to satisfy consumer demand that is highly variable in both the spatial and the temporal domains. In order to be able efficiently to provide high level of QoS to UEs, networks must adjust their configuration in an automatic and timely manner. Antenna vertical tilt angle, referred to as downtilt angle, is one of the most important variables to control for QoS management. The downtilt angle can be modified both in a mechanical and an electronic manner, but owing to the cost associated with manually adjusting the downtilt angle, remote electronic tilt (RET) optimisation is used in the vast majority of modern networks.

There exist several KPIs that may be taken into consideration when evaluating the performance of a RET optimization strategy, and significant existing material is dedicated to Coverage Capacity Optimization (CCO), in which the coverage KPI relates to area covered in terms of a minimum received signal strength, and the capacity KPI relates to the average total throughput in the a given area of interest.

Control of the RET involves a trade-off between coverage and capacity: an increase in antenna downtilt (θ) correlates with a stronger signal in a more concentrated area, as well as higher capacity and reduced interference radiation towards other cells in the network. However, excessive downtilting can result in insufficient coverage in a given area, with some UEs unable to receive a minimum signal quality.

During the past decade, there has been much research into the field of RET optimization using RL methods. However, the majority of existing methods for RET optimisation using RL techniques do not consider any notion of safety, resulting in arbitrary performance disruption during the learning procedure. As reliability of services is one of the most important features for a network provider, the possibility of performance degradation has in effect prohibited the real-world deployment of RL methods for RET optimisation, despite these methods having been shown to outperform the currently used traditional methods in simulated network environments. By addressing the issue of performance degradation through the above described SRL procedures, methods according to the present disclosure can enable the safe deployment of RL Agents for RET optimisation, as discussed below.

For this scenario, the elements of the above discussed architecture may be:

System: A physical base station with at least one radio antenna. Actions which may be implemented by the system comprise possible discrete changes to the antenna downtilt. For example, only three actions may be available: uptilt, downtilt, and no change. In other examples, additional actions may be available, including uptilts and downtilts of differing amounts.

Telecommunication environment: The physical 4G or 5G mobile cellular network area considered for RET optimisation. The state of the environment may be determined by one or more of: cell congestion, cell overlapping, cell interference, cell overshooting, and low Reference Signal Received Power (RSRP) at a cell edge. The reward returned for implementing a particular action may favour actions resulting in any one of: traffic with good RSRP; traffic with good SINR; and reduced congestion.

RL algorithm: An RL algorithm employed by an RL agent whose policy takes as input the state of the mobile cellular network. The Learning Agent's policy may be a DQN.

Rule-based algorithm: An algorithm which utilises existing network domain knowledge to recommend an action, given the state of the mobile cellular network area. One example of such a rule-based algorithm is discussed in detail in “Self-tuning of remote electrical tilts based on call traces for coverage and capacity optimization in LTE”, V. Buenestado et al., IEEE Transactions on Vehicular Technology, vol. 66, no. 5, pp. 4315-4326 May 2017. This algorithm can be used to iteratively compute suggested changes to an antenna tilt angle using cell traces. The algorithm is designed to optimise the trade-off between cell coverage, cell quality, and cell capacity. For example, whilst large cell overlapping often leads to better coverage, the connection quality may be degraded and cell overshooting may be increased. Cell overshooting of a particular cell occurs when a signal strength is measured (for that cell) in distant cells which is close in strength to the signals of their strongest neighbours. Cell overshooting therefore results in useless cell overlap, since cell coverage is not improved and interference level is increased.

To monitor this trade-off, the algorithm first uses an overshooting indicator, Nₒₛ(i), and a useless overlapping indicator, Nₒₗ(i), for a particular cell under study, i, as inputs to a first Fuzzy Logic Controller (FLC). A fuzzy output value of the first FLC, UI(i), quantifies useless interference generated by cell i, and ranges from 0 (no interference) to 1 (large interference).

Nₒₛ(i) is calculated as

$${N}_{os} ( i ) = {\sum }_{j ∈ N ( i )} ( 1 - {X}_{rn} ( j , i ) ) \cdot min ( 1 , \frac{{N}_{{s}_{uon}} ( j , i )}{{N}_{s} ( j ) \cdot {R}_{uon}} ) ,$$

where N(i) is the set of neighbors of cell i; Xᵣₙ(j, i) is an adjacency-level indicator showing whether cell i is a relevant neighbour of cell j, Nₛ(j) is the total number of RSRP samples reported by users in cell j; Nₛ_{ᵤₒₙ}(j,i) (uon for useless overlapping from a non-relevant cell) is the number of samples where the RSRP level difference between the serving cell and neighbour cell i is lower than a pre-defined threshold, ΔRSRPₜₕ_{ₒₛ}, and cell i is not the strongest neighbour; and Rᵤₒₙ is a scaling factor between 0 and 1 that defines the ratio of samples needed to consider the source cell i as a strong interferer of adjacent cell j. The min( ) operator ensures that a neighbour cell i only adds 1 to Nₒₛ(i).

The parameter Xᵣₙ(j, i) is defined as

$${X}_{rn} ( j , i ) = min ( 1 , \frac{{N}_{{s}_{rn}} ( j , i )}{{N}_{s} ( j ) \cdot {R}_{rn}} ) ,$$

where Nₛ_{_{yn}}(j, i) (rn for relevant neighbour) is the number of samples with RSRP values from neighbour cell i higher than the rest of neighbour, and Rᵣₙ is the ratio of relevant samples to consider the source cell i as a totally relevant neighbour of adjacent cell j.

Nₒₗ(i) is calculated as

$${N}_{ol} ( i ) = {\sum }_{j ∈ N ( i )} min ( 1 , \frac{{N}_{{s}_{uo}} ( j , i )}{{N}_{s} ( j ) \cdot {R}_{uo}} ) ,$$

where Nₛ_{ᵤₒ}(j, i) (uo for useless overlapping) is the number of samples where RSRP difference between serving cell j and neighbour cell i is lower than a pre-defined threshold, ΔRSRPₜₕ_{ₒₗ}), and the signal level from the serving cell j is larger than a threshold, RSRP_{high}_{ₜₕ}, and Rᵤₒ is a scaling factor between 0 and 1 defining the ratio of low dominance samples to consider source cell i as a strong interferer of adjacent cell j. Again, the min( ) operator ensures that a neighbour with a large area of useless cell overlapping with cell i only adds 1 to Nₒₗ(i).

The first FLC, taking Nₒₛ(i) and Nₒₗ(i) as inputs, has the following rules:

TABLE I
RULES IN THE FIRST FUZZY LOGIC CONTROLLER

| No. | Nₒₛ(i) | Nₒₗ(i) | UI(i) |
|---|---|---|---|
| 1 | Low | Low | Low |
| 2 | High | Low | High |
| 3 | Low | High | High |
| 4 | High | High | High |

The algorithm then uses UI(i), the output of the first FLC, and a bad coverage indicator, R_{bc}(i), as inputs to a second FLC. A suggested tilt change, Δα(i), is output from the second FLC, which may be positive (downtilt) or negative (uptilt).

R_{bc}(i) is calculated as

$${R}_{bc} ( i ) = \frac{{N}_{bcce} ( i )}{{N}_{ce} ( i )} ,$$

where N_{bcce}(i) is the number of RSRP samples below a certain threshold, RSRP_{low}_{ₜₕ}, reported by cell-edge UEs of cell i, and N_{ce}(i) is the total number of samples reported by cell edge UEs of cell i.

The second FLC, taking UI(i) and R_{bc}(i) as inputs, has the following rules:

TABLE II
RULES IN SECOND FUZZY LOGIC CONTROLLER

| No. | UI(i) | R_{bc}(i) | Δα(i) |
|---|---|---|---|
| 1 | Low | Low | Equal |
| 2 | High | Low | Positive |
| 3 | Low | High | Negative |
| 4 | High | High | Equal |

The suggested tilt change output from the second FLC is therefore known to either improve or maintain the cell coverage, cell quality, and cell capacity of cell i.

This suggested tilt change output is provided to a management node, for example as described above with respect to any of FIGS. 2 to 4, and used to mask any action from the set of available actions that opposes (i.e. is contrary to) the suggested tilt change output. The action to be implemented may then be selected from the remaining available actions.

### Use Case 2: P0 Nominal PUSCH

As with downtilt discussed above, a cell's P0 Nominal PUSCH (Physical Uplink Shared Channel) parameter is also an important network configuration variable to control for QoS management. P0 Nominal PUSCH defines the target power per resource block (RB) which the cell expects in uplink (UL) communication from a UE to a base station. By increasing this parameter, the UL SINR in a particular cell may increase (due to an increased signal strength). At the same time, the UL SINR in the surrounding cells may decrease (due to increased cell interference).

For this scenario, the elements of the above discussed architecture may be:

System: A physical base station with at least one radio antenna. Actions which may be implemented by the system comprise possible discrete changes to the target power per RB expected in UL communication. In the present example, only three actions are available: increase the target power per RB, decrease the target power per RB, or cause no change to the target power per RB. Again, however, additional actions may define differing amounts by which the target power per RB is increased or decreased.

Telecommunication environment: The physical mobile cellular network area (e.g., 4G or 5G). The state of the environment may be determined by at least any one of: cell congestion, cell overlapping, cell interference, cell overshooting, and low RSRP at cell edge. The reward returned for implementing a particular action may favour actions resulting in any one of: traffic with good RSRP; traffic with good SINR; and reduced congestion.

RL algorithm: An RL algorithm employed by an RL agent whose policy takes as input the state of the mobile cellular network. The Learning Agent's policy may be a DQN.

Rule-based algorithm: An algorithm which utilises existing network domain knowledge to recommend an action, given the state of the mobile cellular network area. Those skilled in the art will be able to formulate many suitable rule-based algorithms for the control and/or setting of P0 Nominal PUSCH. For example, the P0 Nominal PUSCH for a particular cell may be controlled as a function of one or more of: the particular cell's throughput; the throughput of one or more cells neighbouring the particular cell; radio measurements on the particular cell and the neighbouring cell(s) performed by UEs served by the particular cell. The P0 Nominal PUSCH value for the particular cell may be increased by an amount where the throughput for the particular cell falls below a threshold, and/or where the throughput for the particular cell is lower than the throughput of neighbouring cells by a threshold. In this way, the UEs served by the particular cell increase their transmission power so as to increase the particular cell's throughput.

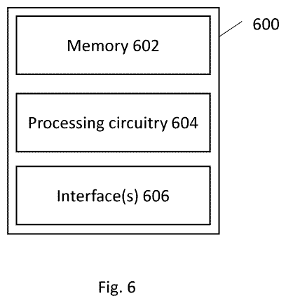

FIG. 6 illustrates a schematic block diagram of an apparatus 600 for managing a system operative in a telecommunication environment. Apparatus 600 is operable to carry out the example method described with reference to FIG. 5 and possibly any other processes or methods disclosed herein. It is also to be understood that the method of FIG. 5 is not necessarily carried out solely by apparatus 600. At least some operations of the method can be performed by one or more other entities.

Apparatus 600 comprises processing circuitry 604, which may include one or more microprocessor or microcontrollers, as well as other digital hardware, which may include digital signal processors (DSPs), special-purpose digital logic, and the like. The processing circuitry 604 may be configured to execute program code stored in memory 602, which may include one or several types of memory such as read-only memory (ROM), random-access memory, cache memory, flash memory devices, optical storage devices, etc. Program code stored in memory 602 includes program instructions for executing one or more telecommunications and/or data communications protocols as well as instructions for carrying out one or more of the techniques described herein, in several embodiments. In some implementations, the processing circuitry 604 may cause the apparatus 600 to perform corresponding functions according one or more embodiments of the present disclosure.

According to embodiments of the disclosure, the processing circuitry 604 is configured to cause the apparatus 600 to: analyse data relating to a state of the telecommunication environment, using a rule-based algorithm, to determine a recommended first action from the set of available actions; remove, from the set of available actions, a second action which opposes the recommended first action, to generate a reduced set of available actions; analyse data relating to a state of the telecommunication environment, using a reinforcement learning algorithm, to select a third action from the reduced set of available actions; and cause the system to implement the third action.

The apparatus 600 may be implemented in a node of a communication network, such as a radio network, an optical network, or an electronic network. Thus the apparatus 600 further comprises one or more interfaces 606 with which to communicate with one or more other nodes of the communication network. The interface(s) 606 may therefore comprise hardware and/or software for transmitting and/or receiving one or more of: radio signals; optical signals; and electronic signals.

In alternative embodiments, the apparatus 600 may comprise one or more units or modules configured to perform the steps of the method, for example, as illustrated in FIG. 5. In such embodiments, the apparatus 600 may comprise an analysing unit, a removing unit, and an implementation unit. The analysing unit may be configured to analyse data relating to a state of the telecommunication environment, using a rule-based algorithm, to determine a recommended first action from the set of available actions. The removing unit may be configured to remove, from the set of available actions, a second action which opposes the recommended first action, to generate a reduced set of available actions. The analysing unit may be further configured to analyse data relating to a state of the telecommunication environment, using a reinforcement learning algorithm, to select a third action from the reduced set of available actions. The implementation unit may be configured to cause the system to implement the third action.

The term “unit” may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended embodiments. The word “comprising” does not exclude the presence of elements or steps other than those listed in an embodiment or claim, “a” or “an” does not exclude a plurality, and a single processor or other unit may fulfil the functions of several units recited in the embodiments. Any reference signs in the claims shall not be construed so as to limit their scope.

1. A computer implemented method for managing a system operative in a telecommunication environment, wherein managing the system comprises causing the system to implement an action, the action being one of a set of available actions, the method comprising:
analysing data relating to a state of the telecommunication environment, using a rule-based algorithm, to determine a recommended first action from the set of available actions;
removing, from the set of available actions, a second action which opposes the recommended first action, to generate a reduced set of available actions;
analysing data relating to a state of the telecommunication environment, using a reinforcement learning algorithm, to select a third action from the reduced set of available actions; and
causing the system to implement the third action.

2. The method according to claim 1, wherein analysing the data using the reinforcement learning algorithm comprises:
obtaining, from a reinforcement learning agent, a plurality of reward values, wherein each reward value relates to an estimated reward for implementing a respective action of the set of available actions, the estimated reward being based on a calculated impact of the respective action on the state of the telecommunication environment, and
wherein the third action is selected based on the plurality of reward values.

3. The method according to claim 2, wherein the third action is selected as the action having a highest reward value of the plurality of reward values.

4. The method according to claim 2, wherein the third action is selected based on a reinforcement learning exploration strategy and the plurality of reward values.

5. The method according to claim 2, further comprising, in response to causing the system to implement the third action:
storing training data comprising the data relating to the state of the telecommunication environment, the third action, a reward value corresponding to the third action, and data relating to an updated state of the telecommunication environment as a result of implementing the third action; and
training the reinforcement learning agent using the stored training data.

6. (canceled)

7. The method according to claim 1, the method further comprising:
refraining from removing any action from the set of available actions responsive to a determination that there is no second action opposing the recommended first action; and
analysing data relating to a state of the telecommunication environment, using the reinforcement learning algorithm, to determine a third action from the set of available actions.

8.-9. (canceled)

10. The method according to claim 1, wherein using the rule-based algorithm comprises:
applying a function to the data relating to the state of the telecommunication environment; and
comparing an output of the function to a threshold, determining the recommended first action based on the comparison.

11. The method according to claim 1, wherein the recommended first action indicates a first change in a configuration of the system and the second action indicates a second change in the configuration of the system, wherein the first change has an opposite effect on the configuration of the system in comparison to the second change.

12. The method according to claim 1, wherein the system comprises at least one antenna, and the set of available actions is for controlling a tilt of the at least one antenna.

13. (canceled)

14. The method according to claim 1, wherein the system comprises at least one antenna, and the set of available actions is for controlling a target power per resource block received by the at least one antenna.

15.-17. (canceled)

18. A management node for managing a system operative in a telecommunication environment, wherein managing the system comprises causing the system to implement an action, the action being one of a set of available actions, the management node comprising processing circuitry configured to:
analyse data relating to a state of the telecommunication environment, using a rule-based algorithm, to determine a recommended first action from the set of available actions;
remove, from the set of available actions, a second action which opposes the recommended first action, to generate a reduced set of available actions;
analyse data relating to a state of the telecommunication environment, using a reinforcement learning algorithm, to select a third action from the reduced set of available actions; and
cause the system to implement the third action.

19. The management node according to claim 18, wherein
being configured to analyse the data using the reinforcement learning algorithm comprises being configured to:
obtain, from a reinforcement learning agent, a plurality of reward values, wherein each reward value relates to an estimated reward for implementing a respective action of the set of available actions, the estimated reward being based on a calculated impact of the respective action on the state of the telecommunication environment, and
wherein the third action is selected based on the plurality of reward values.

20. The management node according to claim 19, wherein the third action is selected as the action having a highest reward value of the plurality of reward values.

21. The management node according to claim 19, wherein the third action is selected based on a reinforcement learning exploration strategy and the plurality of reward values.

22. The management node according to claim 19, the processing circuitry further configured to, in response to causing the system to implement the third action:
store training data comprising the data relating to the state of the telecommunication environment, the third action, a reward value corresponding to the third action, and data relating to an updated state of the telecommunication environment as a result of implementing the third action; and
train the reinforcement learning agent using the stored training data.

23. (canceled)

24. The management node according to claim 18, the processing circuitry further configured to:
refrain from removing any action from the set of available actions responsive to a determination that there is no second action opposing the recommended first action; and
analyse data relating to a state of the telecommunication environment, using the reinforcement learning algorithm, to determine a third action from the set of available actions.

25.-26. (canceled)

27. The management node according to claim 18, wherein being configured to use the rule-based algorithm comprises being configured to:
apply a function to the data relating to the state of the telecommunication environment; and
compare an output of the function to a threshold, determining the recommended first action based on the comparison.

28. The management node according to claim 18, wherein the recommended first action indicates a first change in a configuration of the system and the second action indicates a second change in the configuration of the system, wherein the first change has an opposite effect on the configuration of the system in comparison to the second change.

29. The management node according to claim 18, wherein the system comprises at least one antenna, and the set of available actions is for controlling a tilt of the at least one antenna.

30. (canceled)

31. The management node according to claim 18, wherein the system comprises at least one antenna, and the set of available actions is for controlling a target power per resource block received by the at least one antenna.

32. (canceled)
